(19) United States
(12) Patent Application Publication
(10) Pub. No.: US 2006/0165877 A1
(43) Pub. Date: Jul. 27, 2006

(54) Method for forming inorganic thin film pattern on polyimide resin

(75) Inventors: Hiroshi Yanagimoto, Ashiya-shi (JP); Hidemi Nawafune, Takatsuki-shi (JP); Kensuke Akamatsu, Nagaokakyo-shi (JP)

Correspondence Address: SUGHRUE MION, PLLC, 2100 PENNSYLVANIA AVENUE, N.W., SUITE 800, WASHINGTON, DC, 20037, US

(73) Assignees: MITSUBOSHI BELTING LTD.; TOYOTA JIDOSHA KABUSHIKI KAISHA

(21) Appl. No.: 11/315,200

(22) Filed: Dec. 23, 2005

(30) Foreign Application Priority Data
Dec. 27, 2004 (JP) P.2004-377950

(51) Int. Cl. B05D 3/00; B05D 5/12

(52) U.S. Cl. 427/58; 427/532; 427/180

(57) ABSTRACT

The present invention provides 1. A method for forming an inorganic thin film pattern on a polyimide resin, which has: (1) a step of forming an alkali-resistant protective film having a thickness of 0.01 to 10 μm on a surface of a polyimide resin; (2) a step of removing the alkali-resistant protective film and a superficial portion of the polyimide resin at the site where an inorganic thin film pattern is formed to form a concave part; (3) a step of contacting an alkaline aqueous solution to the polyimide resin in the concave part to cleave an imide ring of the polyimide resin so as to produce a carboxyl group whereby a polyimide resin having the carboxyl group is formed; (4) a step of contacting a solution containing a metal ion to the polyimide resin having the carboxyl group so as to produce a metal salt of the carboxyl group; and (5) a step of separating the metal salt as a metal, a metal oxide or a semiconductor on the surface of the polyimide resin so as to form the inorganic thin film pattern.

### FIELD OF THE INVENTION

The present invention relates to a method for forming an inorganic thin film pattern on a polyimide resin where an inorganic thin film is formed on a surface of a polyimide resin in a fine pattern such as a circuit pattern.

### BACKGROUND OF THE INVENTION

Various methods have been proposed for a method of forming a circuit pattern on the surface of a base material made by polyimide resin such as polyimide film. Among them, a dry process such as vacuum evaporation method and sputtering method have been known as a method which is able to well form a fine circuit pattern having an excellent reliability for close adhesion. However, there is a problem that such a method requires an expensive apparatus and, moreover, it has a low productivity and results in a high cost.

Therefore, as a most common method for forming a circuit pattern, a subtractive method where the whole surface of the polyimide resin base material is coated with a metal film to prepare a metal-coated material and a metal film at the unnecessary site is removed by a photolithographic method by means of an etching treatment has been widely adopted at present. A adhesive force between the polyimide resin base material and the metal film in the metal-coated material is ensured by an anchor effect where the base material surface is made rough or by an adhesive. Although this subtractive method has an excellent productivity and is useful as a method for forming a circuit pattern relatively easily, many metal films are to be removed in the preparation of a circuit pattern and, therefore, there is a problem that much useless metal material is generated. In addition, there has been a demand in recent years for much finer circuit pattern as a result of trend of high density of the electronic circuit substrate but, in a subtractive method, there is another problem that, due to generation of over-etching and to the presence of adhesive or unevenness by roughening of the substrate surface, it is difficult to meet the request for formation of a fine circuit pattern.

In view of the above, there have been brisk studies for methods for circuit pattern formation as a substitute for a subtractive method. For example, an additive method which is a kind of a photolithographic method is a method where a photosensitive resin is applied on the whole surface of a substrate, and a site other than a circuit forming site is irradiated with an ultraviolet ray to cure the site, and then a site which is not cured is removed by a solvent to form a shape of the circuit pattern, and the circuit pattern is directly formed on the substrate surface using non-electrolytic plating. The non-electrolytic method is a method where oxidation-reduction reaction in a solution is utilized and metal film is formed on the substrate surface to which plated catalyst nuclei are given. As compared with the aforementioned dry process, this additive method has an excellent productivity and, as compared with a subtractive method, it is able to form fine circuit pattern. However, since it is difficult to ensure the adhesive force between the polyimide resin base material and the metal film, there is a problem of inferior reliability for close adhesion. There is another problem in the additive method that its steps are complicated and an expensive production facility is necessary for formation of fine circuit pattern resulting in a high cost.

Further, as a method where fine circuit is formed easily and at low cost, an ink jet method has been receiving public attention. In the ink jet method, ink constituted from metal nano-particles is sprayed onto the substrate surface in a pattern form from an ink jet nozzle and, after applying, it is subjected to an annealing treatment to form a circuit pattern comprising a fine metal film. However, when metal nano-particle numbers per unit area of the substrate surface are insufficient in spraying and applying of the metal nano-particles by an ink jet system, there is a possibility that the resulting metal film is broken due to shrinking as a result of sintering among the metal nano-particles upon annealing, while when metal nano-particle numbers are in excess, there is a possibility that flatness and smoothness of the metal film formed after the annealing are lost whereby there is a problem that control of applying amount of the metal nano-particles on the substrate is very severe. In addition, due to their properties, metal component of metal nano-particles and substrate are hardly difficult to achieve a sufficient reliability for close adhesion. Further, there is another problem in precision of the size due to shrinking as a result of sintering among nano-particles upon annealing.

In recent years, there has been proposed an art as an art of formation of a circuit pattern having an excellent reliability for close adhesion where a surface of polyimide resin base material is treated with an aqueous alkali solution to form carboxyl groups, metal ions are coordinated to said carboxyl groups to form metal salts of the carboxyl groups, ultraviolet ray is irradiated onto said polyimide resin base material via a photomask so that the metal ions is selectively reduced to form a metal film and, if necessary, the metal film is made thick by a plating method (e.g., Reference 1). In the metal film formed by that method, a part of it is embedded in the polyimide resin whereby a reliability of close adhesion of the metal film to the polyimide resin substrate surface is able to be highly achieved.

[Reference 1] JP 2001-73159 A

However, in a method for forming a pattern by irradiation of ultraviolet ray via a photomask as in Reference 1, it is difficult to cope with a very fine circuit pattern being demanded as the trend of high density of the circuit substrate. In addition, thickness of the resulting metal film on a level of nm, thickening of the film is necessary in most of the uses for circuit pattern. Thus, it is necessary that a metal film is separated out by a plating method on the circuit pattern of the resulted metal film. However, in a plating method, metal film is separated out in an isotropic manner and, therefore, there is a risk that precision of the pattern is deteriorated after the thickening and, at the same time, reliability for close adhesion lowers. In order to solve such a problem, there is a proposal, for example, where a high-molecular film is formed on the substrate surface which is other than the site where a circuit pattern is formed and then thickening is conducted by a plating method but there is a problem that steps become complicated resulting in a high cost.

### SUMMARY OF THE INVENTION

The present invention has been achieved in view of the above-mentioned circumstances and an object of the present invention is to provide a method for forming an inorganic thin film pattern on a polyimide resin whereby an inorganic thin film is able to be formed on the surface of a polyimide resin with high reliability for close adhesion and high pattern precision and also to provide a method for producing a polyimide resin having a reformed surface for forming an inorganic thin film.

The present inventors have made eager investigation to examine the problem. As a result, it has been found that the foregoing objects can be achieved by the following methods. With this finding, the present invention is accomplished.

The present invention is mainly directed to the following items:

1. A method for forming an inorganic thin film pattern on a polyimide resin, which comprises: (1) a step of forming an alkali-resistant protective film having a thickness of 0.01 to 10 μm on a surface of a polyimide resin; (2) a step of removing the alkali-resistant protective film and a superficial portion of the polyimide resin at the site where an inorganic thin film pattern is formed to form a concave part; (3) a step of contacting an alkaline aqueous solution to the polyimide resin in the concave part to cleave an imide ring of the polyimide resin so as to produce a carboxyl group whereby a polyimide resin having the carboxyl group is formed; (4) a step of contacting a solution containing a metal ion to the polyimide resin having the carboxyl group so as to produce a metal salt of the carboxyl group; and (5) a step of separating the metal salt as a metal, a metal oxide or a semiconductor on the surface of the polyimide resin so as to form the inorganic thin film pattern.

According to the above invention of item 1, an alkaline aqueous is made to act only on a concave part which is not coated with an alkali-resistant protective film so that a carboxyl group is formed on the polyimide resin, and a metal or a metal oxide or a semiconductor is separated on the inner surface of the concave part whereby an inorganic thin film is able to be formed, and the inorganic thin film is able to be formed in the concave part of the site where a pattern is formed. Thus, the inorganic thin film is able to be formed with a high reliability for close adhesion and a high precision of the pattern.

2. The method for forming an inorganic thin film pattern on a polyimide resin according to item 1, wherein, in the step (2), the concave part is formed by removing the alkali-resistant protective film and the superficial portion of the polyimide resin by an irradiation of a laser or an irradiation of a vacuum ultraviolet ray.

According to the above invention of item 2, when an irradiation of a laser or an irradiation of a vacuum ultraviolet ray is carried out, not only the alkali-resistant protective film but also the superficial portion of the polyimide resin are able to be removed whereby a concave part is formed.

3. The method for forming an inorganic thin film pattern on a polyimide resin according to item 1, wherein, in the step (5), the metal salt is subjected to a reducing treatment to be separated as a metal on a surface of the polyimide resin so as to form a metal thin film.

According to the above invention of item 3, as a result of a reducing treatment of the metal salt, a thin metal film is able to be formed on the site where an inorganic thin film is formed and a circuit pattern is formed by the thin metal film whereby it is able to be used as an electronic circuit substrate, etc. in which polyimide resin is a base material.

4. The method for forming an inorganic thin film pattern on a polyimide resin according to item 1, wherein, in the step (5), the metal salt is reacted with an activated gas to be separated as a metal oxide or a semiconductor on a surface of the polyimide resin so as to form a metal oxide thin film or a semiconductor thin film.

According to the above invention of item 4, as a result of the reaction of the metal salt with the activated gas, a thin film of a metal oxide or a thin film of a semiconductor is able to be formed at the site where an inorganic thin film is formed whereby it is now able to be used as various electronic parts having a thin film of a metal oxide or a thin film of a semiconductor.

5. The method for forming an inorganic thin film pattern on a polyimide resin according to item 1, wherein, in the step (5), the inorganic thin film pattern comprises an aggregate of inorganic nano-particles.

According to the above invention of item 5, the close adhesion strength of the inorganic thin film is able to be enhanced by activating the anchor locking effect of the aggregate of the inorganic nano-particles, and a non-electrolytic plating is able to be easily carried out on the surface of the inorganic thin film by activating the catalytic activity of the aggregate of the inorganic nano-particles.

6. The method for forming an inorganic thin film pattern on a polyimide resin according to item 1, wherein, in the step (5), a part of the aggregate of inorganic nano-particles is embedded in the polyimide resin.

According to the above invention of item 6, the inorganic thin film comprising the aggregate of the inorganic nano-particles is able to be strongly adhered to the polyimide resin closely by a high anchor locking effect of the aggregate of the inorganic nano-particles to the polyimide resin.

7. The method for forming an inorganic thin film pattern on a polyimide resin according to item 1, which further comprises, after the step (5), (6) a step of subjecting to a non-electrolytic plating on the surface of the polyimide resin on which the inorganic thin film pattern is separated.

8. The method for forming an inorganic thin film pattern on a polyimide resin according to item 5, which further comprises, after the step (5), (6) a step of subjecting to a non-electrolytic plating on the surface of the polyimide resin on which the inorganic thin film pattern is separated.

According to the above invention of items 7 and 8, a non-electrolytically plated film is formed on the surface of the inorganic thin film so that thickness of the inorganic thin film is able to be made thick and a circuit of the electronic circuit substrate is able to be formed by the inorganic thin film.

9. The method for forming an inorganic thin film pattern on a polyimide resin according to item 8, wherein, in the step (6), the non-electrolytic plating is carried out by using the aggregate of the inorganic nano-particles as a nucleus for separation of plating.

According to the above invention of item 9, the non-electrolytic gilt is separated on the surface of the inorganic thin film comprising an aggregate of the inorganic nano-particles whereby a non-electrical plating is able to be conducted selectively on the surface of the inorganic thin film, the non-electrolytically plated film is produced in the inner area of the concave where the inorganic thin film is formed and, in thickening the inorganic thin film with the electronically plated film, a pattern precision is able to be maintained even after the thickening.

10. The method for forming an inorganic thin film pattern on a polyimide resin according to item 1, wherein the inorganic thin film pattern has a shape of a circuit pattern.

According to the above invention of item 10, a circuit is able to be formed by the inorganic thin film which is formed at the site where the pattern is formed and that is able to be used as an electronic circuit substrate or the like in which the polyimide resin is used as a base material.

In accordance with the present invention, an alkaline aqueous solution is made to act only on the concave part which is not coated with an alkali-resistant protective film so that carboxyl group is produced in the polyimide resin, and a metal or a metal oxide or a semiconductor is separated on the inner surface of the concave part so that the inorganic thin film is able to be formed, and formation of the inorganic thin film is able to be done in the concave part of the site where the pattern is formed. Thus, the inorganic thin film is able to be formed in a high reliability for close adhesion and in a high pattern precision.

### BRIEF DESCRIPTION OF THE DRAWINGS

FIG. 1A to 1G shows an example of embodiments of the present invention, and each is a schematic cross-sectional view.

The reference numerals used in the drawings denote the followings, respectively.

1: polyimide resin base material

2: alkali-resistant protective film

3: concave part

4: alkaline aqueous solution

5: reformed portion

6: reformed portion containing metal ion

7: inorganic thin film

8: non-electronically plated film

### DETAILED DESCRIPTION OF THE INVENTION

Hereinafter, the present invention will be described in detail.

Polyimide resin is a polymer having a cyclic imide structure in the main chain being produced, for example, by imidation of polyamic acid and is a thermosetting resin having excellent heat resistance, resistance to chemicals, mechanical strength, resistance to flame, electric insulation, etc. In the present invention, film, molded plate or the like of the polyimide resin can be used as base materials and there is no particular limitation for its shape.

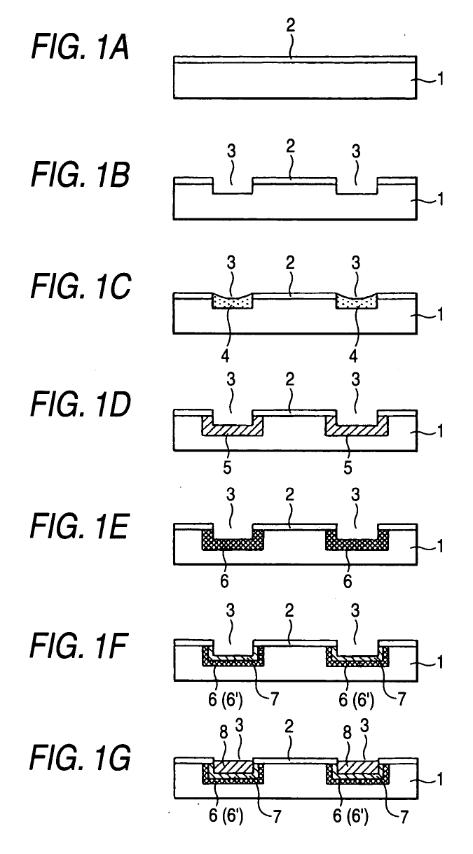

In the present invention, firstly in the step (1), a protective film 2 having an excellent resistance to alkali is formed on the whole surface of the polyimide resin base material 1 as shown in FIG. 1A. Although there is no particular limitation for the material constituting the alkali-resistant protective film 2, that which can be easily removed in the latter step is preferred and its examples are an alkali-resistant resin component and an inorganic high-molecular component. When an acidic solution is used in the latter step, it is desired that the protective film has resistance to acid in addition to resistance to alkali. With regard to the resin component forming the alkali-resistant protective film 2, preferred ones are polyether imide, polystyrene, polyethylene, polypropylene, polyacrylate, polyvinyl chloride, etc. and, with regard to the inorganic high-molecular component, preferred ones are polyoxysiloxane, etc.

In the formation of the alkali-resistant protective film 2, it is able to be carried out in such a manner that, for example, the resin component and the inorganic high-molecular component are dissolved in a solvent and the resulting liquid or paste is applied on the surface of the polyimide resin base material 1. There is no particular limitation for the applying method and its examples are spin coating method, dipping method, screen printing method, flexographic method and bar coating method. The solvent may be appropriately selected depending upon the component and the applying method and, to be more specific, THF is preferred for polyether imide, toluene is preferred for polystyrene, hot ligroin is preferred for polyethylene and toluene is preferred for polypropylene. Ethyl cellulose or the like is unable to be used because of its low resistance to alkali.

The alkali-resistant protective film 2 coats the whole area of the surface of the polyimide base material 1 and film thickness is set at 0.01 to 10 μm, and more preferably at 0.03 to 4 μm. When film thickness of the alkali-resistant protective film 2 is less than 0.01 μm, there is a possibility that it does not play a role as a protective film while, when the thickness is more than 10 μm, it is difficult to form a concave part 3 on the polyimide resin base material 1 in the next step (2).

After the alkali-resistant protective film 2 is formed on the surface of the polyimide resin base material 1 as mentioned above, the alkali-resistant protective film 2 and the superficial portion of the polyimide resin base material 1 are removed along the predetermined optional pattern shape in the step (2) whereby a concave part 3 is formed in a pattern shape as shown in FIG. 1B.

Formation of the concave part 3 is able to be carried out in such a manner that, using a laser drawing apparatus for example, laser such as a femtosecond laser, an ultraviolet laser, a green laser or a YAG laser is irradiated from the upper area of the alkali-resistant protective film 2 by scanning along a pattern shape. It is also possible to conduct in such a manner that a vacuum ultraviolet ray (VUV) irradiating machine is used and the vacuum ultraviolet ray is irradiated onto the upper area of the alkali-resistant protective film 2 via a photomask. When a laser irradiation or a vacuum ultraviolet ray irradiation is conducted as such, not only the alkali-resistant protective film 2 but also the superficial portion of the polyimide base material 1 under that are able to be removed and a concave part 3 is able to be formed on the surface of the polyimide base material 1. In the conventional photolithographic method or the like where the alkali-resistant protective film 2 is removed in a pattern form using a solvent, such a concave part 3 is unable to be formed on the surface of the polyimide base material 1.

Although there is no particular limitation for the depth of the concave part 3, it is preferably within a range of 0.5 to 15 μm and, more preferably within a range of 1 to 10 μm. Here, the alkali-resistant protective film 2 is a chemically stable film and remains without being removed at last and, therefore, depth of the concave part 3 includes the film thickness of the alkali-resistant protective film 2 and is a depth from the surface of the alkali-resistant protective film 2 to the bottom of the concave part 3.

Then, in the step (3), an alkaline aqueous solution 4 is applied on the surface of the polyimide resin base material 1 or the polyimide resin base material 1 is dipped in the alkaline aqueous solution 4 so that the surface of the polyimide resin base material 1 is treated with the alkaline aqueous solution 4. There is no particularly limitation for the alkaline aqueous solution 4 and its examples are aqueous solution of potassium hydroxide, aqueous solution of sodium hydroxide, aqueous solution of calcium hydroxide, aqueous solution of magnesium hydroxide and aqueous solution of ethylenediamine. There is no particular limitation for the concentration of the alkaline aqueous solution 4 and it is preferably 0.01 to 10 M and more preferably 0.5 to 6 M. It is also possible to add an auxiliary agent selected from binder resin, organic solvent, inorganic filler, thickener, leveling agent, etc. to the alkaline aqueous solution 4 to adjust viscosity, wetting property to the polyimide resin base material, flatness/smoothness and volatility. They are preferred to be selected depending upon shape and line width of the applied pattern.

In the treatment with the alkaline aqueous solution 4 as such, the alkaline aqueous solution 4 selectively acts only on the concave 3 which is not coated with the alkali-resistant protective film 2 in the surface of the polyimide resin base material 1 as shown in FIG. 1C. In that case, when the alkaline aqueous solution 4 acts on the surface of the polyimide resin base material 1, carboxyl group (—COOA; alkaline metal salt or alkaline earth metal salt of carboxylic acid) and amide bond (—CONH—) by cleavage of imide ring in a molecular structure of polyimide resin are produced as noted from chemical reaction formula (I) as shown in Patent Document 1.

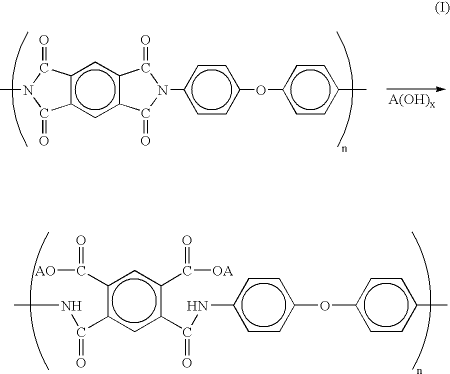

wherein A represents an alkaline metal or an alkaline earth metal.

Accordingly, when the surface of the polyimide resin base material 1 as shown by FIG. 1B is treated with the alkaline aqueous solution 4 and selectively contacted only to the concave part 3 of the polyimide resin base material 1 as shown in FIG. 1C, carboxyl group is formed on the superficial portion of the polyimide resin base material 1 and the reformed portion 5 is formed in a pattern along site where the pattern is formed.

Here, as the alkaline aqueous solution 4 permeates into the surface of the concave 3 of the polyimide resin base material 1 as shown above, carboxyl group is formed and the reforming reaction of the polyimide resin proceeds. When time for treating with the alkaline aqueous solution 4 is made long or the polyimide resin base material 1 is subjected to a heating treatment, thickness of the reformed portion 5 is able to increase. The treating temperature for treating the surface of the polyimide resin base material 1 by the alkaline aqueous solution 4 is preferably 10 to 80° C. or, more preferably, 15 to 60° C. Treating time is preferably 5 to 1,800 seconds or, more preferably 30 to 600 seconds.

After the reformed portion 5 where carboxyl group is produced in the inner surface of the concave part 3 of the polyimide resin base material 1 in the step (3) as shown above, the surface of the polyimide resin base material 1 is treated with a solution containing metal ion in the step (4). With regard to the metal ion in the solution containing a metal ion, at least one selected from gold ion, silver ion, copper ion, platinum ammine complex, palladium ammine complex, tungsten ion, tantalum ion, titanium ion, tin ion, indium ion, cadmium ion, vanadium ion, chromium ion, manganese ion, aluminum ion, iron ion, cobalt ion, nickel ion and zinc ion may be listed. Among those metal ions, platinum amine complex and palladium ammine complex are used in a state of alkaline solution, and metal ions other than them are used in a state of acid solution.

The surface of the polyimide resin base material 1 is treated with a solution containing a metal ion as such and the reformed portion 5 where carboxylic group is produced as above is contacted to a solution containing a metal ion whereby the metal ion (M²⁺) is coordinated to carboxyl group as shown below for example
—COO⁻ . . . M²⁺ . . . ⁻OOC—
whereby a metal salt of carboxyl group (metal salt of carboxylic acid) is able to be produced and, as shown in FIG. 1E, a reformed portion 6 containing metal ion is able to be formed at the place of the reformed portion 5. In the present invention, a “reformed portion containing metal ion” means a reformed portion having a metal salt of carboxyl group as mentioned above. At that time, it is possible to advance the coordinate exchange between metal ion and hydroxyl group, alkali metal or alkali earth metal in carboxyl group formed in the polyimide resin by increasing the degree of dissociation of hydroxyl group, alkali metal or alkali earth metal. For such a purpose, it is necessary to keep the polyimide resin base material 1 in an acidic state and, therefore, it is preferred in such a case to use an acidic solution containing a metal ion as a solution containing a metal ion.

Concentration of metal ion in the solution containing a metal ion has a close correlation to a ligand substitution reaction of hydroxyl group, alkali metal or alkali earth metal in carboxyl group formed in the polyimide resin with metal ion. Although it varies depending upon the metal ion species, concentration of metal ion is preferably 1 to 1,000 mM and, more preferably 10 to 500 mM. Low metal ion concentration is not preferred because time until the ligand substitution reaction reaches equilibrium becomes too long. Contacting time of the solution containing a metal ion to the surface of the polyimide resin base material 1 is preferably 10 to 600 seconds and, more preferably 30 to 420 seconds.

As mentioned above, in the step (4), a solution containing a metal ion is contacted to the reformed portion 5 of the inner surface of the concave part 3 of the polyimide resin base material 1 and a reformed portion 6 containing metal ion where a metal salt of carboxyl group is formed and, after that, the surface of the polyimide resin base material 1 is preferably washed with water or alcohol to remove unnecessary metal ion. Then, in the step (5), metal salt in the reformed portion 6 containing metal ion is separated as metal or is separated as metal oxide or semiconductor whereby an inorganic thin film 7 comprising metal or an inorganic thin film 7 comprising metal oxide or semiconductor is able to be formed on the inner surface of the concave part 3 of the polyimide resin base material 1. As shown in FIG. 1F, the inorganic thin film 7 is formed on the surface layer of the reformed portion 6 containing metal ion on the inner surface of the concave part 3. The composition of the reformed portion 6 containing metal ion changes so as to decrease the amount of the metal ion contained therein by separating the metal salt contained therein as a metal, a metal oxide or a semiconductor on the surface of the reformed portion 6 containing metal ion. Specifically, after the step (5), the composition of the reformed portion 6 containing metal ion has changed to be a reformed portion 6′ in which no metal ion remains or a reformed portion 6′ in which part of the metal ions remain, depending on the thickness of the reformed portion 6 containing metal ion, or the type or the degree of treatments described below etc. In case the metal salt of the reformed portion 6 containing metal ion is separated as metal, it is able to be conducted by subjecting the metal salt to a reducing treatment. The reducing treatment is able to be carried out by, for example, treating the surface of the polyimide resin base material 1 with a solution containing a reducing agent or by subjecting the polyimide resin base material 1 to a heating treatment in an atmosphere of reducing gas or inert gas. Condition for the reduction varies depending upon the metal ion species and, in the case of treatment with a solution containing a reducing agent, it is possible to use a reducing agent such as sodium borohydride, phosphinic acid or a salt thereof or dimethylamine borane. In the case of treatment with a reducing gas, it is possible to use a reducing gas such as hydrogen and a mixed gas thereof or a mixed gas of borane with nitrogen, and in the case of treatment with inert gas, it is possible to use inert gas such as nitrogen gas or argon gas.

In the case where metal salt of the reformed portion 6 containing metal ion is separated as a metal oxide or a semiconductor, it is able to be carried out by treating the metal salt with activated gas. The condition for the treatment varies depending upon the metal ion species and a treatment is able to be conducted using oxygen and a mixed gas thereof, nitrogen and a mixed gas thereof, sulfur and a mixed gas thereof, etc. as the activated gas and the surface of the polyimide resin base material 1 is contacted to the activated gas.

Examples of the metal oxide include titanium oxide, tin oxide, indium oxide, vanadium oxide, manganese oxide, nickel oxide, aluminum oxide, iron oxide, cobalt oxide, zinc oxide, barium titanate, strontium titanate, compounded oxide of indium and tin, compounded oxide of nickel and iron and compounded oxide of cobalt and iron. When an inorganic thin film 7 comprising metal oxide as such is formed on the surface of the resin base material 1, the product is able to be used, for example, as condenser, transparent electrically conductive film, heat releasing material, magnetic recording material, electrochromic element, sensor, catalyst and luminescent material.

Examples of the semiconductor include cadmium sulfide, cadmium telluride, cadmium selenide, silver sulfide, copper sulfide and indium phosphide. When an inorganic thin film 7 comprising such a semiconductor is formed on the surface of the polyimide resin base material 1, it is now able to be used, for example, as luminescent material, transistor and memory material.

Metal, metal oxide or semiconductor constituting the inorganic thin film 7 formed by the step (5) as mentioned above is preferably constituted from nano-particles having a particle size of 2 to 100 nm. Due to their very high surface energy, the inorganic nano-particles are easily aggregated and are present as an aggregate of inorganic nano-particles. At that time, although the degree varies depending upon the aforementioned metal ion concentration, reducing agent concentration, atmosphere temperature and activated gas concentration, a part of the inorganic particle aggregate is stabilized in the resin of the polyimide resin base material 1 or, in other words, a part of the inorganic nano-particle aggregate is in a state of being embedded in the surface layer of the polyimide resin and, by an anchor locking effect at that time, the polyimide resin base material 1 and the inorganic thin film 7 comprising the inorganic nano-particle aggregate are able to be strongly and tightly adhered. Especially in the common anchor locking effect achieved by chemical or physical roughening of the surface of the base material, the surface roughness is on a level of μm but, in the anchor locking effect of the inorganic nano-particles and the polyimide resin as in the present invention, an excellent close adhesion characteristic is able to be achieved even when the surface roughness is on a nanometer level and that is suitable for a wiring material for transmittance of electronic signal in a high frequency region.

As mentioned above, an inorganic thin film 7 is able to formed on the concave part 3 of a polyimide resin base material 1 and, when the concave part 3 is set in a shape of a circuit pattern, a circuit pattern is able to be formed by the inorganic thin film 7 and the polyimide resin base material 1 is able to be utilized to an electronic part such as an electronic circuit substrate. The inorganic thin film 7 is formed in the concave part 3 formed on the surface of the polyimide resin base material 1. Accordingly, the inorganic thin film 7 is hardly detached from the concave part 3 whereby the inorganic thin film 7 is able to be formed highly closely adhesive and, along the concave part 3, the inorganic thin film 7 is able to be formed highly precisely. Thus, in forming the circuit pattern by an inorganic thin film 7, it is able to be formed in high reliability for close adhesion and in high pattern precision.

Here, the inorganic thin film 7 having a thickness about 10 to 500 nm can be formed by the aforementioned step (5). On the other hand, in an electronic circuit substrate, it is necessary that the film thickness of the circuit is about several μm level. Therefore, in using as an electronic circuit substrate, it is preferred that thickening is applied to the inorganic thin film 7 and film thickness of the circuit is made thick. Thus, after the step (5), non-electrolytic plating is conducted on the surface of the inorganic thin film 7 formed on the polyimide resin base material 1 whereby film thickness of the inorganic thin film 7 is able to be made thick by non-electrolytic plating in the step (6).

The non-electrolytic plating is able to be carried out, for example, by dipping the polyimide resin base material 1 in a non-electrolytic plating bath. At that time, a non-electrolytically plated film 8 is able to be separated on the surface of the inorganic thin film 7 using the aforementioned aggregate of nano-particles forming the inorganic thin film 7 as a nucleus for separation of the plating as shown in FIG. 1G. Thus, since the aggregate of the inorganic nano-particles has a very large specific surface area, it shows an excellent catalytic activity and, when it is used as a separating nucleus for separation of the non-electrolytically plated film 8, separation of plated film starts uniformly from many points whereby it is possible to give a non-electrolytically plated film 8 showing good close adhesion and electric characteristics. As a result of separation of the non-electrolytically plated film 8 on the surface of the inorganic thin film 7 using the inorganic nano-particle aggregate as a separating nucleus for the plating as such, the non-electrolytically plated film 8 is able to be formed selectively on the surface of the inorganic thin film 7 among the surfaces of the polyimide resin base material 1. The non-electrolytically plated film 8 is formed along the inner part of the concave part 3 where the inorganic thin film 7 is formed and, in forming a circuit by thickening of the inorganic thin film 7 with the non-electrolytically plated film 8, precision of circuit pattern is able to be maintained by the concave part 3 even after thickening of the film. Accordingly, thickness of the non-electrolytically plated film 7 is not more than the depth of the concave part 3. When the inner area of the concave part 3 is completely filled with the non-electrolytically plated film 8, thickness of the non-electrolytically plated film 8 may be more than the depth of the concave part 3. When thickness of the non-electrolytically plated film 8 is more than the depth of the concave part 3, it is preferred that the non-electrolytically plated film 8 exceeding the depth is removed by means of abrasion, for example, by a mechanical means such as grinding or a chemical means such as etching. Incidentally, in order to prevent the re-reforming of the polyimide resin base material 1, the non-electrolytically plating bath is preferred to be a neutral or weakly alkaline non-electrolytically plating bath.

### EXAMPLES

The present invention is now illustrated in greater detail with reference to Examples and Comparative Examples, but it should be understood that the present invention is not to be construed as being limited thereto.

### Example 1

Polyimide film (manufacture by DuPont-Toray Co., Ltd; trade name: Kapton 200-H) was dipped in an ethanol solution, subjected to an ultrasonic cleaning for 5 minutes and dried in an oven at 100° C. for 60 minutes to clean the surface of the polyimide film.

In the meanwhile, a polystyrene solution was prepared by dissolving 50 parts by mass of polystyrene in 180 parts by mass of toluene and the polystyrene solution was uniformly applied on the surface of the polyimide film by a spin coating method under the condition of 1,500 rpm for 30 seconds. After that, it was kept for 10 minutes in an oven which was kept at 60° C. to form an alkali-resistant protective film of polystyrene on the polyimide film (refer to FIG. 1A). Film thickness of the alkali-resistant protective film was 0.5 μm.

Then an ultraviolet laser apparatus was used, a circuit pattern with a line width of 5 μm was drawn under the following conditions and the alkali-resistant protective film and the superficial portion of the polyimide film were removed to form a concave part in a pattern shape on the polyimide film (refer to FIG. 1B). Depth of the concave part was 3 μm.

| Laser output | 5 | W |
|---|---|---|
| Wavelength | 355 | nm |
| Oscillating operation | pulse | |
| Scanning speed | 30 | mm/second |

Then the aforementioned polyimide film was dipped for 5 minutes into an aqueous solution of KOH of 5 M concentration where the temperature was adjusted to 50° C. to treat with an alkaline aqueous solution (refer to FIG. 1C). After that, the polyimide film was dipped in an ethanol solution and subjected to an ultrasonic cleaning for 10 minutes. On the surface of the polyimide film, a reformed portion was formed in a circuit pattern shape (refer to FIG. 1D).

Then, an aqueous solution of CuSO₄ in 50 mM concentration was used as an acidic solution containing metal ion, the polyimide film was dipped in this aqueous solution for 5 minutes and Cu ion was coordinated to the reformed portion to form a reformed portion containing the metal ion (refer to FIG. 1F). After that, an excessive CuSO₄ was removed with distilled water.

Then, an aqueous solution of NaBH₄ in 5 mM concentration was used as a reducing solution and the polyimide film was dipped for 5 minutes in the aqueous solution and washed with distilled water whereby separation of thin copper film was confirmed on the surface of the reformed portion containing metal ion on the inner surface of the concave part (refer to FIG. 1F). Thickness and line width of the thin copper film were 300 nm and 5 μm, respectively. Electric resistance of the thin copper film was 5×10⁻³ Ωcm and a circuit pattern having the same shape as the concave part was able to be formed.

After that, the polyimide film was dipped for 3 hours in a neutral non-electrolytic copper plating bath having the following bath composition where the temperature was adjusted to 50° C.

| | | |
|---|---|---|
| CuCl₂ | 0.05 | M |
| Ethylenediamine | 0.60 | M |
| Co(NO₃)₂ | 0.15 | M |
| Ascorbic acid | 0.01 | M |
| 2,2′-Dipyridyl | 20 | ppm |

| | |
|---|---|
| pH | 6.75 |

The non-electrolytically plated copper film was separated on the thin copper film in the concave part and a uniform plated copper film where film thickness was 3 μm was prepared (refer to FIG. 1G). Electric resistance of the copper plated film was 3×10⁻⁵ Ωcm and the aforementioned thin copper film and the above copper plated film were able to form a circuit of electronic circuit substrate.

### Example 2

Acrylate resin (10 parts by mass) was dissolved in 80 parts by mass of terpineol to prepare an acrylate resin paste. Then, the acrylate resin paste was applied by a screen printing method via a screen plate of 300 meshes of SUS and 5 μm of emulsifier on the surface of polyimide film where the surface was cleaned in the same manner as in Example 1 and kept for 30 minutes in an oven of 110° C. to form an alkali-resistant protective film of the acrylate resin on the surface of the polyimide film (refer to FIG. 1A). Film thickness of this alkali-resistant protective film was 10 μm.

Then a circuit pattern of line width of 40 μm was drawn under the following condition using a YAG laser apparatus and the alkali-resistant protective film and the superficial portion of the polyimide film were removed to form a concave part in a pattern shape on the polyimide film (refer to FIG. 1B). Depth of the concave part was 18 μm.

| Laser output | 50 | W |
|---|---|---|
| Wavelength | 1064 | nm |
| Oscillating operation | pulse | |
| Scanning speed | 100 | mm/second |

In the meanwhile, 30 parts by mass of polyethylene glycol was added as a thickener to 100 parts by mass of aqueous solution of KOH in 10 M concentration and dissolved by stirring to prepare an alkaline aqueous solution. The alkaline aqueous solution was applied on the surface of the polyimide film by a bar coating method in a film thickness of 50 μm and heated for 30 minutes in a belt furnace where the peak temperature was kept at 40° C. to treat with the alkaline aqueous solution (refer to FIG. 1C). After that, the polyimide film was dipped in a propanol solution and an ultrasonic cleaning was carried out for 10 minutes. On the surface of the polyimide film, a reformed portion was formed in a circuit pattern shape (refer to FIG. 1D).

Then, an aqueous solution of AgNO₃ in a concentration of 100 mM was used as an acidic aqueous solution containing metal ion and the polyimide film was dipped for 5 minutes in the aqueous solution containing the metal ion so that silver ion was coordinated to the reformed portion on the inner surface of the concave part whereby a reformed portion containing metal ion was formed (refer to FIG. 1E). After that, an excessive AgNO₃ was removed by distilled water.

Then hydrogen gas was used as a reducing gas and a reducing treatment was carried out for 30 minutes in a 50% hydrogen stream (N₂ balance) of 200° C. whereby separation of thin silver film was confirmed on the surface of the reformed portion containing metal ion (refer to FIG. 1F). Thickness and line width of the thin silver film were 300 nm and 40 μm, respectively and electric resistance of the thin silver film was 5×10⁻³ Ωcm whereby a circuit pattern having the same shape as the concave part was able to be formed.

After that, the polyimide film was dipped for 5 hours in a neutral non-electrolytic plating bath having the following bath composition where the temperature was adjusted to 80° C.

| NiSO₄ | 0.1 M |
|---|---|
| CH₃COOH | 1.0 M |
| NaH₂PO₂ | 0.2 M |
| pH | 4.5 |

In the concave part, the non-electrolytically plated nickel film was separated on the thin silver film to give a uniform plated nickel film where film thickness was 16 μm (refer to FIG. 1G). Electric resistance of the plated nickel film was 3×10⁻⁵ Ωcm and it was possible to form a circuit of electronic circuit substrate from the aforementioned thin silver film and the above plated nickel film.

### Example 3

Polypropylene (30 parts by mass) was dissolved in 180 parts by mass of toluene to prepare a polypropylene solution. Then, the polypropylene solution was uniformly applied by a dipping method under the condition of pulling-up speed of 20 mm/second on the polyimide film where the surface was cleaned in the same manner as in Example 1 and kept for 5 minutes in an oven kept at 40° C. to form an alkali-resistant protective film of the polypropylene on the surface of the polyimide film (refer to FIG. 1A). Film thickness of this alkali-resistant protective film was 0.03 μm.

Then a circuit pattern of line width of 3 μm was drawn under the following condition using a femtosecond laser apparatus and the alkali-resistant protective film and the superficial portion of the polyimide film were removed to form a concave part in a pattern shape on the polyimide film (refer to FIG. 1B). Depth of the concave part was 3 μm.

| Laser output | 10 | W |
|---|---|---|
| Wavelength | 780 | nm |
| Oscillating operation | pulse | |
| Scanning speed | 30 | mm/second |

Then the aforementioned polyimide film was dipped for 10 minutes in an aqueous solution of KOH in 2 M concentration where temperature was adjusted to 70° C. and treated with the alkaline aqueous solution (refer to FIG. 1C). After that, the polyimide film was dipped in water and an ultrasonic cleaning was conducted for 10 minutes. On the surface of the polyimide film, a reformed portion was formed in a circuit pattern shape (refer to FIG. 1D).

Then, an aqueous solution of indium sulfate in a concentration of 0.1 M and an aqueous solution of tin sulfate in a concentration of 0.1 M were mixed to prepare an aqueous solution containing metal ions in which molar ratio of indium ion to tin ion in terms of In/Sn was 15/85. The polyimide film was dipped for 20 minutes in the aqueous solution containing the metal ions so that indium ion and tin ion were coordinated to the reformed portion on the inner surface of the concave part whereby a reformed portion containing metal ions was formed (refer to FIG. 1E). After that, excessive metal ions were removed by distilled water.

Then the polyimide film was subjected to a heating treatment in a hydrogen atmosphere at 350° C. for 3 hours to prepare an aggregate of nano-particles comprising indium-tin alloy. At that time, film thickness of the aggregate of the nano-particles was 50 nm. After that, the polyimide film was subjected to a heating treatment in an air atmosphere under the condition of 300° C. for 6 hours so that the indium-tin alloy was made to react with oxygen whereby ITO thin film was formed on the inner surface of the concave part (refer to FIG. 1F). Line width of this thin ITO film was 3 μm and sheet resistance thereof was 0.7 Ω/□.

### Example 4

To a solution where 50 parts by mass of polydimethylsiloxane was mixed with 100 parts by mass of an aqueous solution of ethylenediamine in 5 M concentration were added 35 parts by mass of polyvinylpyrrolidone and 25 parts by mass of glycerol as thickeners and the mixture was dissolved by stirring to prepare a polydimethylsiloxane paste. The polydimethylsiloxane paste was uniformly applied by a flexographic printing on the surface of polyimide film where the surface was cleaned by the same manner as in Example 1 and subjected to a heating treatment for 10 minutes in a belt furnace keeping the peak temperature at 150° C. to form an alkali-resistant protective film of polydimethylsiloxane on the surface of the polyimide film (refer to FIG. 1A). Film thickness of the alkali-resistant protective film was 8 μm.

Then a circuit pattern of a line width of 20 μm was drawn under the following condition using a vacuum ultraviolet irradiating apparatus and the alkali-resistant protective film and the superficial portion of the polyimide film were removed whereby the concave part in a pattern shape was made into a polyimide film (refer to FIG. 1B). Depth of the concave part was 10 μm.

| | | |
|---|---|---|
| Output | 100 | W |
| Wavelength | 172 | nm |
| Degree of vacuum | 10 | Pa |
| Irradiating time | 300 | minutes |

Then the aforementioned polyimide film was dipped for 50 minutes in an aqueous solution of Mg(OH)₂ in 7 M concentration where the temperature was adjusted to 60° C. and treated with an alkaline aqueous solution (refer to FIG. 1C). After that, the polyimide film was dipped in water and subjected to an ultrasonic cleaning for 10 minutes. On the surface of the polyimide film, a reformed portion was formed in a circuit pattern shape (refer to FIG. 1D).

Then the polyimide film was dipped for 3 minutes in an acidic aqueous solution containing metal ion comprising an aqueous solution of cadmium nitrate in a concentration of 50 mM so that cadmium (II) ion was coordinated in the reformed portion on the inner surface of the concave part to form a reformed portion containing metal ion (refer to FIG. 1E). After that, an excessive cadmium nitrate was removed by distilled water.

Then an aqueous solution comprising a composition of sodium sulfide of 100 ppm concentration, disodium hydrogen phosphate of 5 mM concentration and potassium dihydrogen phosphate of 5 mM concentration was kept at 30° C. and the polyimide film was dipped for 20 minutes therein to conduct a sulfurating treatment whereby an aggregate of nano-particles of cadmium sulfide was prepared. The treatment after the aforementioned treatment with the alkaline aqueous solution was repeated for ten times whereby the concentration of nano-particles of cadmium sulfide was increased.

After that, a heating treatment was carried out in an air atmosphere under the condition of 300° C. for 5 hours to form a thin cadmium sulfide film (refer to FIG. 1F). Line width and film thickness of the thin cadmium sulfide film were 20 μm and 2.3 μm, respectively.

### Comparative Example 1

Polystyrene (10 parts by mass) was dissolved in 180 parts by mass of toluene to prepare a polystyrene solution and the polystyrene solution was uniformly applied by a spin coating method under the condition of 3,000 rpm and 30 seconds on the surface of the polyimide film where the surface was cleaned in the same manner as in Example 1. After that, it was kept for 10 minutes in an oven kept at 60° C. to form an alkali-resistant protective film of the polystyrene on the surface of the polyimide film. Film thickness of this alkali-resistant protective film was 0.008 μm.

Then a circuit pattern of line width of 5 μm was drawn under the following condition using an ultraviolet laser apparatus and the alkali-resistant protective film and the superficial portion of the polyimide film were removed to form a concave part in a pattern shape on the polyimide film (refer to FIG. 18). Depth of the concave part was 4 μm.

| Laser output | 5 | W |
|---|---|---|
| Wavelength | 355 | nm |
| Oscillating operation | pulse | |
| Scanning speed | 30 | mm/second |

Then the aforementioned polyimide film was dipped for 5 minutes in an aqueous solution of KOH in 5 M concentration where temperature was adjusted to 50° C. and treated with the alkaline aqueous solution. After that, the polyimide film was dipped in an ethanol solution and an ultrasonic cleaning was conducted for 10 minutes. On the surface of the polyimide film, a reformed was formed in a circuit pattern shape.

Then, an aqueous solution of CuSO₄ in a concentration of 50 mM was used as an acidic solution containing metal ion and the polyimide film was dipped for 5 minutes in the aqueous solution so that Cu ion was coordinated to the reformed portion whereby a reformed portion containing metal ions was formed. After that, an excessive CuSO₄ was removed by distilled water.

Then the polyimide film was dipped in an aqueous solution of NaBH₄ in a concentration of 5 mM as a reducing solution for 5 minutes and washed with distilled water whereby separation of thin copper film was noted not only in the concave part but also on the surface of the polyimide film other than the concave part whereby no circuit pattern was able to be formed.

### Comparative Example 2

Acrylate resin (30 parts by mass) was dissolved in 80 parts by mass of terpineol to prepare an acrylate resin paste. Then, the acrylate resin paste was applied by a screen printing method via a screen plate of 200 meshes of SUS and 20 μm of emulsifier on the surface of polyimide film where the surface was cleaned in the same manner as in Example 1 and kept for 30 minutes in an oven of 110° C. to form an alkali-resistant protective film of the acrylate resin on the surface of the polyimide film. Film thickness of this alkali-resistant protective film was 15 μm.

Then a circuit pattern of line width of 40 μm was drawn under the following condition using a YAG laser apparatus to form a concave part in a pattern shape. Depth of the concave part was 12 μm and it did not penetrate into the alkali-resistant protective film and did not reach the surface of the polyimide film.

| Laser output | 50 | W |
|---|---|---|
| Wavelength | 1064 | nm |
| Oscillating operation | pulse | |
| Scanning speed | 20 | mm/second |

Then the aforementioned polyimide film was dipped for 5 minutes in an aqueous solution of KOH in 5 M concentration where the temperature was adjusted to 50° C. and subjected to a treatment with an alkaline aqueous solution. After that, the polyimide film was dipped in an ethanol solution and an ultrasonic cleaning was carried out for 10 minutes. On the surface of the polyimide film, formation of a reformed was unable to be confirmed.

### Comparative Example 3

Ethyl cellulose (30 parts by mass) was dissolved in 100 parts by mass of terpineol to prepare an ethyl cellulose solution. Then, the ethyl cellulose solution was applied by a screen printing method via a screen plate of 300 meshes of SUS and 5 μm of emulsifier on the surface of polyimide film where the surface was cleaned in the same manner as in Example 1 and kept for 30 minutes in an oven of 110° C. to form an ethyl cellulose film on the surface of the polyimide film. Film thickness of this ethyl cellulose film was 5 μm.

Then a circuit pattern of line width of 40 μm was drawn under the following condition using a YAG laser apparatus and the ethyl cellulose film and superficial portion of the polyimide film were removed to form a concave part in a pattern shape on the polyimide film (refer to FIG. 1B). Depth of the concave part was 18 μm.

| Laser output | 50 | W |
|---|---|---|
| Wavelength | 1064 | nm |
| Oscillating operation | pulse | |
| Scanning speed | 100 | mm/second |

Then the aforementioned polyimide film was dipped for 5 minutes in an aqueous solution of KOH in 5 M concentration where the temperature was adjusted to 50° C. and subjected to a treatment with an alkaline aqueous solution. After that, the polyimide film was dipped in an ethanol solution and an ultrasonic cleaning was carried out for 10 minutes. As a result of the alkaline treatment as such, the ethyl cellulose film was dissolved in an aqueous solution of KOH and, on the surface of the polyimide film, no protective film was present.

As described above, the present invention is able to be widely utilized in the manufacture of electronic parts and mechanical parts, particularly in the manufacture of circuit board such as flexible circuit board, flex rigid circuit board and carrier for TAB.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2004-377950 filed on Dec. 27, 2004, and the contents thereof are incorporated herein by reference.

What is claimed is:

1. A method for forming an inorganic thin film pattern on a polyimide resin, which comprises:
(1) a step of forming an alkali-resistant protective film having a thickness of 0.01 to 10 μm on a surface of a polyimide resin;
(2) a step of removing the alkali-resistant protective film and a superficial portion of the polyimide resin at the site where an inorganic thin film pattern is formed to form a concave part;
(3) a step of contacting an alkaline aqueous solution to the polyimide resin in the concave part to cleave an imide ring of the polyimide resin so as to produce a carboxyl group whereby a polyimide resin having the carboxyl group is formed;
(4) a step of contacting a solution containing a metal ion to the polyimide resin having the carboxyl group so as to produce a metal salt of the carboxyl group; and
(5) a step of separating the metal salt as a metal, a metal oxide or a semiconductor on the surface of the polyimide resin so as to form the inorganic thin film pattern.

2. The method for forming an inorganic thin film pattern on a polyimide resin according to claim 1,
wherein, in the step (2), the concave part is formed by removing the alkali-resistant protective film and the superficial portion of the polyimide resin by an irradiation of a laser or an irradiation of a vacuum ultraviolet ray.

3. The method for forming an inorganic thin film pattern on a polyimide resin according to claim 1,
wherein, in the step (5), the metal salt is subjected to a reducing treatment to be separated as a metal on a surface of the polyimide resin so as to form a metal thin film.

4. The method for forming an inorganic thin film pattern on a polyimide resin according to claim 1,
wherein, in the step (5), the metal salt is reacted with an activated gas to be separated as a metal oxide or a semiconductor on a surface of the polyimide resin so as to form a metal oxide thin film or a semiconductor thin film.

5. The method for forming an inorganic thin film pattern on a polyimide resin according to claim 1,
wherein, in the step (5), the inorganic thin film pattern comprises an aggregate of inorganic nano-particles.

6. The method for forming an inorganic thin film pattern on a polyimide resin according to claim 1,
wherein, in the step (5), a part of the aggregate of inorganic nano-particles is embedded in the polyimide resin.

7. The method for forming an inorganic thin film pattern on a polyimide resin according to claim 1, which further comprises, after the step (5),
(6) a step of subjecting to a non-electrolytic plating on the surface of the polyimide resin on which the inorganic thin film pattern is separated.

8. The method for forming an inorganic thin film pattern on a polyimide resin according to claim 5, which further comprises, after the step (5),
(6) a step of subjecting to a non-electrolytic plating on the surface of the polyimide resin on which the inorganic thin film pattern is separated.

9. The method for forming an inorganic thin film pattern on a polyimide resin according to claim 8,
wherein, in the step (6), the non-electrolytic plating is carried out by using the aggregate of the inorganic nano-particles as a nucleus for separation of plating.

10. The method for forming an inorganic thin film pattern on a polyimide resin according to claim 1,
wherein the inorganic thin film pattern has a shape of a circuit pattern.
